(19) United States
(12) Patent Application Publication
(10) Pub. No.: US 2024/0062141 A1
(43) Pub. Date: Feb. 22, 2024

(54) SYSTEMS AND METHODS FOR ESTIMATING LEAD TIME PREDICTION

(71) Applicant: Airspace Technologies, Inc., Carlsbad, CA (US)

(72) Inventors: Spence Lunderman, Sherman Oaks, CA (US); Ksenia Palke, Carlsbad, CA (US); Michael Scott Weber, San Marcos, CA (US)

(73) Assignee: Airspace Technologies, Inc., Carlsbad, CA (US)

(21) Appl. No.: 17/888,985

(22) Filed: Aug. 16, 2022

(51) Int. Cl. G06Q 10/08; G01C 21/34

(52) U.S. Cl. CPC G06Q 10/0833; G01C 21/3438; G01C 21/3484

(57) ABSTRACT

A method and system to estimate lead time for delivery of a good is disclosed. In aspects, the method performs steps of: receiving a user request to transport the good; identifying a plurality of drivers for transporting the good within a virtual area; determining an expected response time to receive an acceptance of a job corresponding to the user request from a driver in the plurality of drivers; estimating an expected lead time using the expected response time and an expected travel time; and transmitting the expected lead time to the user.

### TECHNICAL FIELD

The present disclosure relates to a logistical management system for estimating delivery lead time for use in transportation and logistics.

### BACKGROUND

Transportation and logistics have become essential technologies as the demand for transporting goods and/or personnel from place-to-place continues growing. Transporting goods often involves complex scheduling problems. Tools have evolved that facilitate interactions between shippers, buyers, transporters, etc. While these tools provide added convenience to the various users, the tools also exacerbate the scheduling problems. It follows that optimized and more accurately scheduled transportation would improve the usability of these tools and increase customer satisfaction.

### SUMMARY

Provided herein are system, apparatus, device, method and/or computer program product embodiments, and/or combinations and sub-combinations thereof, for estimating lead times in a logistical management system using an optimized lead-time algorithm.

Generally speaking, wait time may arise in a logistical management system for both a customer (an individual or company) and a potential carrier (e.g., a driver on the road). For instance, when a customer makes a request for a delivery of a good or package via a user's electronic device, there may be a number of available drivers nearby who can receive the request via an application implemented on an electronic device. The driver may accept the request, decline the request, or the request may time out. The customer then waits until one of the available drivers accepts the request to deliver the good. During this process, the customer may receive an estimated total delivery time period for the entire process to complete.

When placing an order, customers may receive an estimated total delivery period that reflects the time that it will take for a driver to pick up a package from a requested location (e.g., a current location of the user or a user specified location) and deliver the package to the final delivery location. The customer may also receive an estimation of “lead time” that reflects how long it will take for a driver to accept a request and arrive at the point of departure. However, in some cases, a driver among the number of available drivers may accept the request right away, and in other cases, all of the drivers in the specified range may reject the request. Thus, there may be a significant amount of wait time until an available driver accepts the request that is not considered by legacy systems in calculating the estimated total delivery period. Thus, the provided estimated total delivery period may not be accurate given the lack of consideration of wait time.

Accordingly, a need exists to accurately estimate a wait time when calculating the estimated total delivery period. A technical benefit is realized over legacy systems by employing an optimized algorithm for determining wait time for a specific order, the number of drivers available, the drivers' location, the nature of those drivers (i.e., the past behaviors of these drivers), and a host of other factors.

To any extent that legacy systems attempt to include wait time in an estimated delivery time at all, these systems use a simplistic method for estimating wait time, e.g., adding a static value to the estimated delivery time (e.g., 5 minutes, 10 minutes, etc.). In other words, legacy systems have no efficient, working method to assess the impact of the multitude of variables in play in a particular scenario, i.e., the number of drivers and a multitude of factors about each driver as well as the nature of the order and the customer, etc. so as to estimate wait time in the manner described in further detail below.

Accordingly, a need exists to estimate wait time in a manner that considers these various factors. A technical benefit is realized over legacy systems by employing an algorithm that determines all possible solicitation sequences for a set of drivers. After determining all possible solicitation sequences for a set of drivers, the technique estimates a probability and duration for each sequence using trained machine learning models. The estimated probability and duration then allow the algorithm to estimate a total lead time across all the drivers and incorporate this estimated lead time into the estimated total delivery period and otherwise inform the customer of the wait time.

A further technical benefit is realized by optimizing the lead-time estimation algorithm to efficiently provide a result that considers the above-described factors at a time-scale required by such a logistics management tool. For one, the initial set of sequences is constrained from an infinite number of solicitation sequences using an appropriate threshold (e.g., a time-out threshold, a path-length threshold, and a probability threshold). For example, solicitation sequences that end with a driver accepting the solicitation are not carried forward within the algorithm. Additionally, the algorithm may save floating point operations (and thus computation time) by creating an augmented matrix of condensed solicitation sequences by reducing time-out operations in solicitation sequences. A partial solicitation sequence's probability may be calculated once and then carried forward to the calculations of subsequent sequence probabilities. These optimization techniques may require orders of magnitude fewer floating point operations, allowing the algorithm to deliver a result that can be used in the context of estimating a total delivery time.

A further technical benefit is realized by training a machine learning model to estimate the probabilities relied upon by the optimized lead-time algorithm so as to estimate the durations. The training and deployment of this machine learning model allows the probability estimates to consider a host of driver-specific factors and tailoring the estimate to the circumstances of the actual order. The trained model also delivers these estimated probabilities at a time-scale suitable for the tool.

Accordingly, systems and methods of performing logistical management for estimating lead time are provided. In a non-limiting aspect, a method may include receiving a user request to transport a good in a shipping platform, wherein the user request includes a pickup location and a delivery location; identifying a plurality of drivers for transporting the good within a virtual area that includes the pickup location and the delivery location; determining an expected response time to receive an acceptance of a job corresponding to the user request from a driver in the plurality of drivers using a stochastic process; estimating an expected lead time using the expected response time and an expected travel time based on a location of the driver and the pickup location; and transmitting the expected lead time to the user in the shipping platform.

Another aspect of the present disclosure is directed to a non-transitory computer-readable device having instructions stored thereon. In a non-limiting aspect, the non-transitory computer-readable device may cause the at least one computing device to perform: receiving a user request for transporting of a good via a shipping platform, wherein the request includes a pickup location and a delivery location; identifying a plurality of eligible drivers for transporting the good within a virtual area that includes the pickup location and the delivery location; determining an expected response time to receive an acceptance of the request from a driver in the plurality of drivers using a stochastic process; estimating an expected lead time using the expected response time and an estimated expected travel time that is derived based on a trained driver model for transporting of the good; and transmitting the expected lead time to the user in the shipping platform.

Still another aspect is directed to a system for estimating lead time. In a non-limiting aspect, the system may include a memory; and at least one processor coupled to the memory and configured to receive a user request for transporting of a good via a shipping platform, wherein the request includes a pickup location and a delivery location; identify a plurality of eligible drivers for transporting the good within a virtual area that includes the pickup location and the delivery location; determine an expected response time to receive an acceptance of the request from a driver in the plurality of drivers using a stochastic process; estimate an expected lead time using the expected response time and an estimated expected travel time that is derived based on a trained driver model for transporting of the good; and transmit the expected lead time to the user in the shipping platform.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the pertinent art to make and use the disclosure.

FIG. 1 is a functional block diagram depicting a logistical management system for estimating lead-time, according to aspects of the present disclosure.

FIG. 2 is a sequence diagram depicting communication between various components of a logistical system, according to aspects of the present disclosure.

FIG. 3 is a flowchart depicting a method of operating the logistical management system to receive a request for delivery of a package from a user in order to facilitate estimating lead-time, according to aspects of the present disclosure.

FIG. 4 is a graphical illustration of a plurality of drivers in a virtual map, according to aspects of the present disclosure.

FIG. 5 is a flowchart depicting a method of operating the logistical management system to determine a response time to receive an acceptance of a job, according to aspects of the present disclosure.

FIG. 6A shows a graphical illustration of exemplary responses to delivery of a package, according to aspects of the present disclosure.

FIGS. 6B and 6C show a graphical illustration of exemplary soliciting scenarios when there are a plurality of available drivers, according to aspects of the present disclosure.

FIG. 6D shows a graphical illustration of an exemplary probability of one scenario when there are a plurality of available drivers, according to aspects of the present disclosure.

FIG. 6E is an illustrative probability tree diagram for calculating scenario probabilities, according to aspects of the present disclosure.

FIG. 7 is a flowchart depicting a method of operating the logistical management system to determine a probability for each solicitation sequence, according to one aspect of the present disclosure.

FIG. 8 is a flowchart depicting a method of operating the logistical management system to determine a probability for each solicitation sequence, according to another aspect of the present disclosure.

FIGS. 9A and 9B are graphs comparing results obtained by probability calculation with and without using an iterative process, according to aspects of the present disclosure.

FIG. 10 is an example architecture of the components implementing the computing system, according to aspects of the present disclosure.

### DETAILED DESCRIPTION

This specification discloses one or more aspects that incorporate the features of this disclosure. The disclosed aspect(s) merely exemplify the present disclosure. The scope of the present disclosure is not limited to the disclosed aspect(s). The present disclosure is defined by the claims appended hereto.

The aspect(s) described, and references in the specification to “one aspect,” “an aspect,” “an example aspect,” etc., indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of one skilled in the art to affect such feature, structure, or characteristic in connection with other aspects whether or not explicitly described.

It is to be appreciated that the Detailed Description section, and not the Summary and Abstract sections, is intended to be used to interpret the claims. The Summary and Abstract sections may set forth one or more but not all exemplary aspects of the present disclosure as contemplated by the inventor(s), and thus, are not intended to limit the present disclosure and the appended claims in any way.

The drawings showing the aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the disclosures may be operated in any orientation.

The term “module” or “unit” referred to herein may include software, hardware, or a combination thereof in the aspects of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements.

A functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and application programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server. The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Specific examples of operably couplable include, but are not limited, to physically mateable and/or physically interacting components, and/or wirelessly interactable, and/or wirelessly interacting components, and/or logically interacting, and/or logically interactable components.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

In the following detailed description, reference is made to the accompanying drawings, which form a part hereof. In the drawings, similar symbols typically identify similar or identical components or items, unless context dictates otherwise. The illustrative aspects described in the detailed description, drawings, and claims are not meant to be limiting. Other aspects may be utilized, and other changes may be made, without departing from the spirit or scope of the subject matter presented here.

### System Overview and Function

Logistical management systems can for example provide end-to-end suites for managing the transport of goods from receipt of an order to transportation of goods to a destination location, such as the logistical management systems described in U.S. Pat. No. 11,315,067 issued on Apr. 26, 2022 and/or in U.S. Pat. No. 10,936,992 issued on Mar. 2, 2021, each of which are incorporated herein by reference in their entireties.

There can be a number of tasks or actions associated with management of transport of goods for the order including, for example, commissioning, tracking, or instructing transporters that transport the goods, approving optimal transportation routes for the goods, ensuring that client-specific instruction (e.g., special operational instructions (SOP)) are implemented for the order, ensuring that communication is made at the right time and to the right contacts during the course of an order. In addition, when an order for transporting a good has been placed, a customer needs to be notified with delivery time information before an available driver is confirmed. Thus, it is important to avoid or reduce as much as possible a latency between the order request and an order acceptance of a driver for providing delivery time information to the customer.

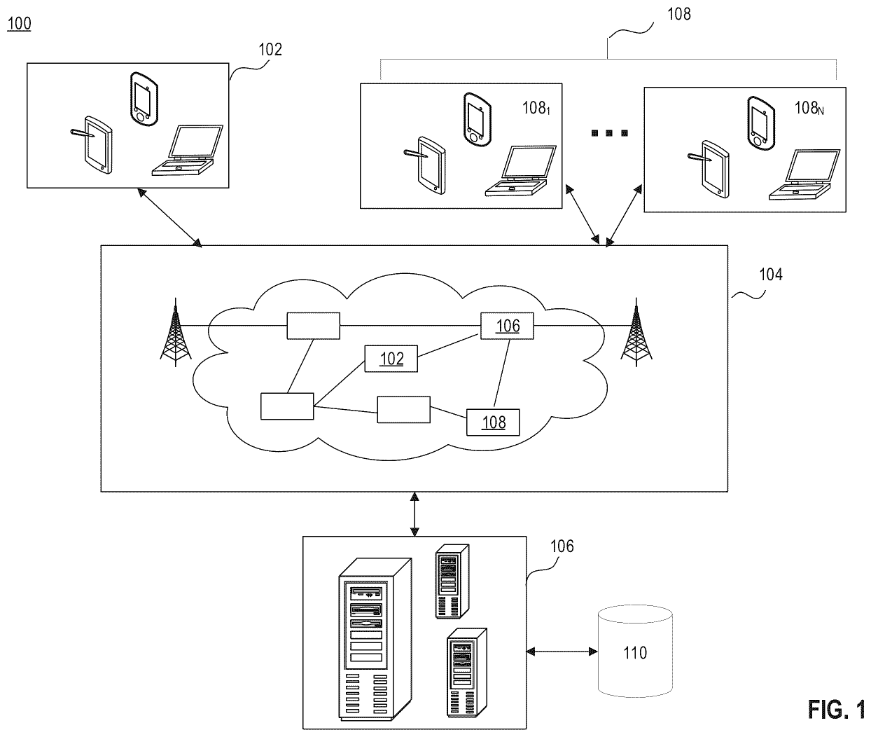

This section will give a detailed description of various aspects of a logistical management system with reference to FIGS. 1-5, 6A-6D, 7, and 8.

FIG. 1 shows a logistical management system 100 for estimating a lead time, according to aspects of the present disclosure. Estimating a lead time as used throughout this disclosure refers to the way in which the logistical management system 100 estimates and calculates the amount of time it takes for a driver to arrive at a pick up location after a customer places an order for delivering a good or goods. The terms “good,” “goods,” and “package” are interchangeable as used throughout the disclosure. In non-limiting aspects, the logistical management system 100 can include a first device 102, such as a customer device, connected to a second device 106, such as a server. The logistical management system 100 can further include a plurality of third devices 108₁ . . . and 108_{N} (collectively and generically referred to as “third device 108”), such as a user device (e.g., driver device). In non-limiting aspects, the first device 102 and the second device 106 can communicate with each other through a network 104, such as a wireless or wired network. Similarly, the third device 108 and the second device 106 can communicate with each other through the network 104. In some aspects, the first device 102 may communicate with the third device 108 through the network 104. The second device 106 may comprise one or more computer systems, and may also be communicatively coupled to a data store element 110. The data store element 110 may comprise a conventional database system according to various aspects. Alternatively, the data store element 110 may comprise a portion of the second device 106 and be integral to it.

The network 104 can span and represent a variety of telecommunication networks and network topologies. For example, the network 104 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 104. Cable, Ethernet, digital subscriber line (DSL), fiber optic lines, fiber to the home (FTTH), and plain old telephone service (POTS) are examples of wired communication that may be included in the network 104. Further, the network 104 can traverse a number of network topologies and distances. For example, the network 104 can include direct connection, personal area network (PAN), local area network (LAN), metropolitan area network (MAN), wide area network (WAN), or a combination thereof

In non-limiting aspects, the first device 102 may be any of a variety of devices, such as a smart phone, a cellular phone, a personal digital assistant, a tablet computer, a notebook computer, a laptop computer, or a desktop computer. In non-limiting aspects, the first device 102 can couple, either directly or indirectly, to the network 104 to communicate with the second device 106 or may be a stand-alone device.

In non-limiting aspects, the second device 106 may be any variety of centralized or decentralized computing devices. For example, the second device 106 may be a laptop computer, a desktop computer, grid-computing resources, a virtualized computing resource, cloud computing resources, routers, switches, peer-to-peer distributed computing devices, a server, a server farm, or a combination thereof. In non-limiting aspects, the second device 106 may be centralized in a single room, distributed across different rooms, distributed across different geographic locations, or embedded within the network 104. In non-limiting aspects, the second device 106 can couple with the network 104 to communicate with the first device 102 and/or the third device 108, or the second device 106 may be a stand-alone device.

In non-limiting aspects, the third device 108, may be any variety of devices, such as a smart phone, a cellular phone, a personal digital assistant, a tablet computer, a notebook computer, a laptop computer, or a desktop computer, or may be integrated in a carputer of a vehicle. In non-limiting aspects, the third device 108 can couple, either directly or indirectly, to the network 104 to communicate with the second device 106 or may be a stand-alone device. In further non-limiting aspects, the third device 108 can couple, either directly or indirectly, to the network 104 to communicate with the first device 102, or the third device 108 may be a stand-alone device.

In various aspects, the data store element 110 may be a cloud system and contain segment information to be used to generate routes and to estimate a travel time between a first location and a second location. For instance, the data store element 110 may contain data segments for a plurality of drivers, road information (e.g., speed limit, the number of traffic lights, etc.), time of day information (e.g., rush hour, etc.) and the like. The data store element 110 may communicate with the second device 106 directly or indirectly, and communicate, separately or together, with, separately or together, the first device 102 and the third device 108 directly or indirectly.

For illustrative purposes, the logistical management system 100 is shown with the first device 102, the second device 106, and the third device 108 as end points of the network 104, although it is understood that the logistical management system 100 can have a different partition between the first device 102, the second device 106, the third device 108, and the network 104. For example, the first device 102, the second device 106, and the third device 108 can also function as part of the network 104.

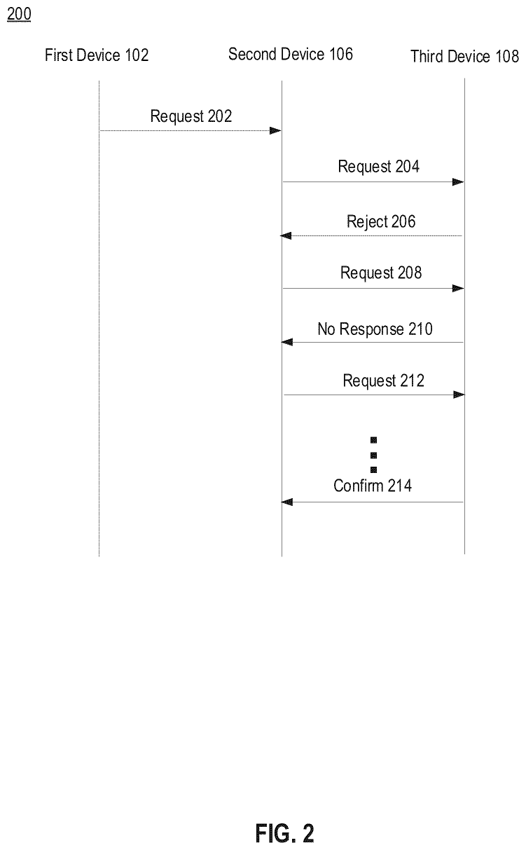

FIG. 2 is a sequence diagram 200 illustrating one way the various components of logistical management system 100 can work together to affect the transport of an item. For clarity, the sequence diagram of FIG. 2 will be described with reference to FIG. 1, but it should be understood that this is for explanatory purposes only and that the principles outlined in FIG. 2 are not so limited to the specific aspects of FIG. 1.

As shown in the sequence diagram 200, the first device (or customer device) 102 may send a request message 202 to the second device (or control system) 106 via communication network 104. Throughout the disclosure, the terms “request,” “solicit,” and “solicitation” may be interchangeable used for referring to an act of asking, e.g., a package delivery, to one or more drivers. The request message 202 may include information relating to a particular item or package that needs to be transported as well as a GPS location of current and delivery locations of the package. The second device 106 then may send a request message 204 to one or more third devices 108 upon receipt of the request message 202. The request message 204 may contain information relating to the specifics of the package to be transported and the GPS location information. In a case in which the third device 108 sends a reject message 206, e.g., when a driver rejects the package delivery request, the second device 106 may send a request message 208 to another one or more third devices 108. The second device 106 may receive no response 210 for a certain period of time or may receive a hold or time-out request from the third device 108, that is, a driver selects a time-out option or does not response to the request for the certain period of time, or the second device 106 may receive another reject message. Then, the second device 106 may send another request message 212 and repeat the process until one of a plurality of third devices 108 sends a confirmation message 214 to the second device 106. At this point, the sequence may automatically or optionally end.

When the second device 106 receives the request message 202, the second device 106 may estimate a lead time and provide this lead time estimate to the first device 102, so that the customer using the first device 102 may have an estimate of the amount of time it will take before an assigned driver arrives to pick up the package. Throughout the disclosure, the “lead time” is understood as the time from the moment the customer places an order (the moment the supplier learns of the requirement) to the moment the assigned driver arrives to pick up the package to be delivered.

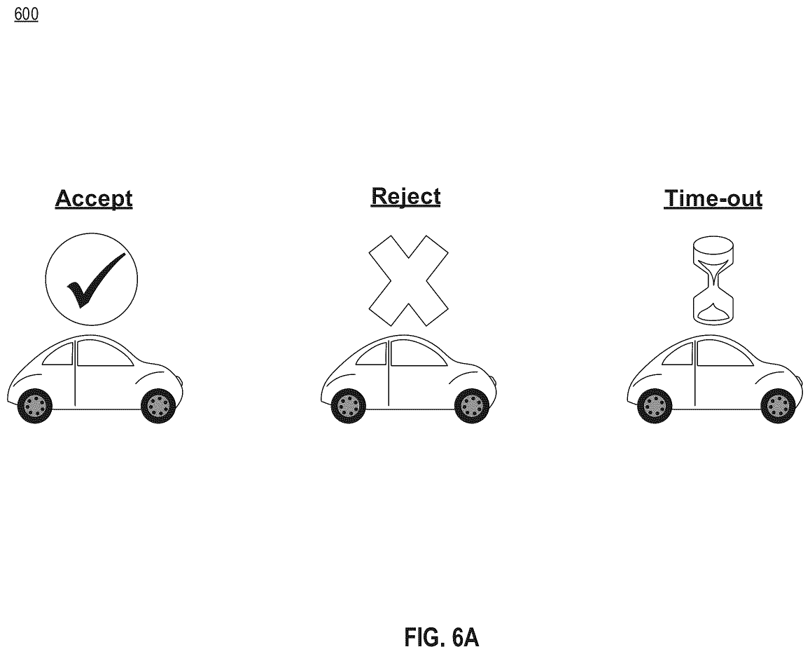

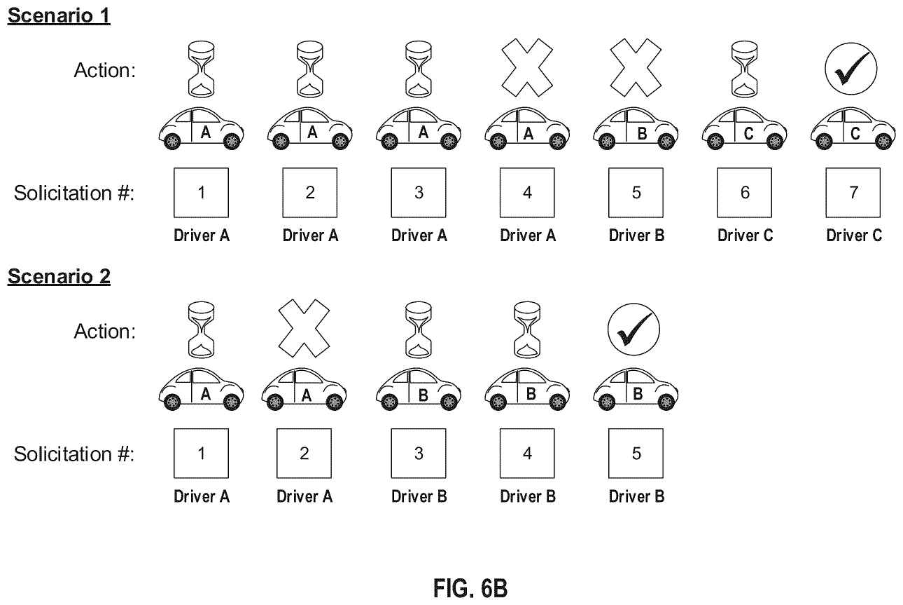

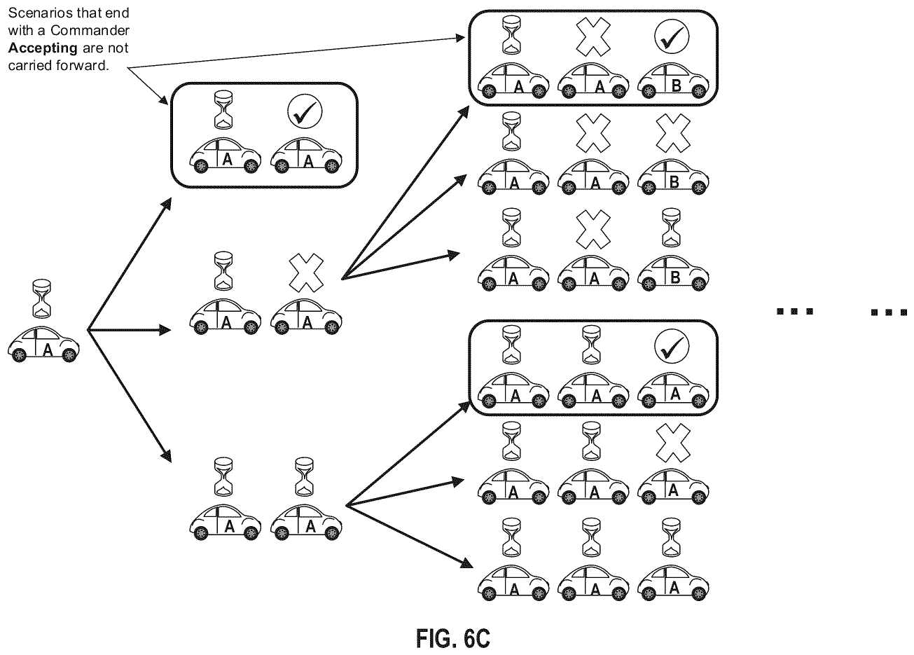

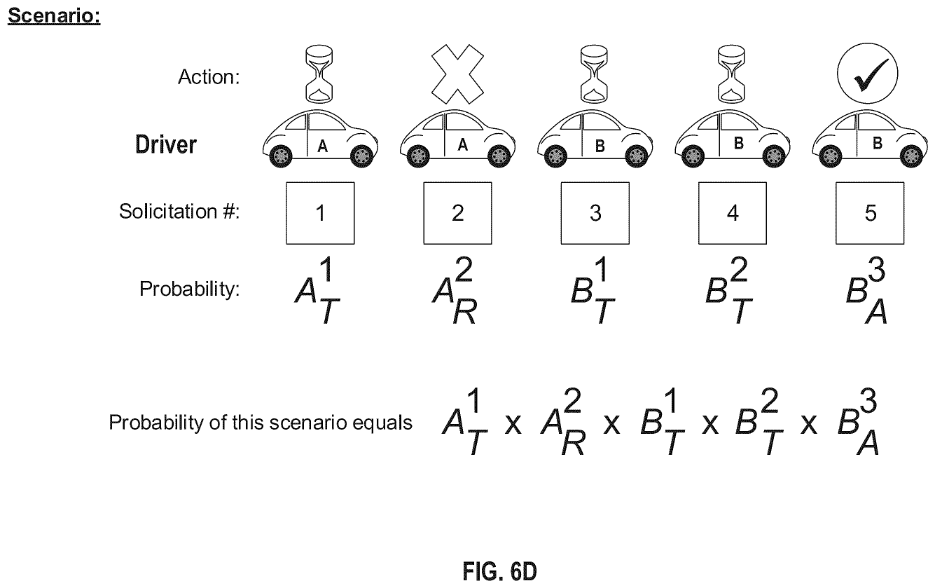

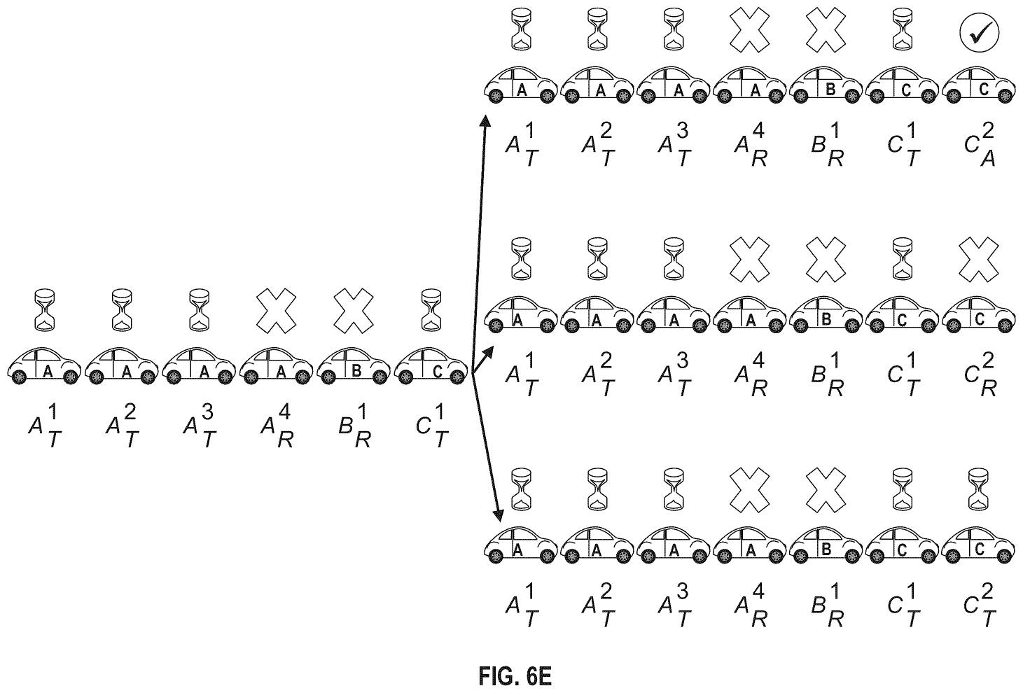

Describing the driver's response in detail, e.g., referring to FIG. 6A, a potential driver, who may be using the third device 108, has three potential reactions to the request message 208 according to various aspects. The potential driver may accept the request, reject the request, or time-out by not responding to the request within a predetermined period of time. In order to accurately estimate an expected lead time, the second device 106 may consider the probabilities of these responses, combined with the durations correlated with each of these responses. Moreover, various sequences of responses may be generated, and the probabilities of all of these sequences may be included in a larger calculation that may generate an expected lead time. Estimating the probabilities and the lead time according to various aspects will be described more in detail later in this disclosure.

In a trivial case, if one of the available drivers accepts the package delivery task as soon as the first device 102 sends the request message 202 (e.g., the third device 108 response to the request message 204 in the sequence diagram 200), the customer may expect that the assigned driver will promptly arrive to pick up the package for delivery to the final destination. However, if there is no available driver nearby or one or more drivers reject or time-out (e.g., neither accepting nor rejecting the order for a certain period of time) the order, a delay in the expected arrival time of the assigned driver to pick up the package occurs. In this case, without the benefit of an expected lead time, the customer needs to wait for an unpredictable time until one available driver finally accepts and confirms the package delivery request.

One important aspect of transporting items or packages from one location to another is providing the total delivery time taken from the order request until the package delivery is completed. The delivery time from the package pickup location to the destination can be simply calculated based on the route information between the locations (pickup location and destination) with or without considering the other facts such as speed limits on the roads, number of traffic lights, real-time traffic information, time of day, etc. However, the lead time can be unexpectedly varied since it is not possible to know which driver will accept the delivery request when a customer places a request. The system and method described in the disclosure can provide the lead time even before a driver is assigned without delay. Moreover, when the customer receives the expected lead time, the customer may also be able to more accurately calculate the total time it will take for the package to arrive at the final delivery destination. The lead time estimation process will be described more in detail hereinafter.

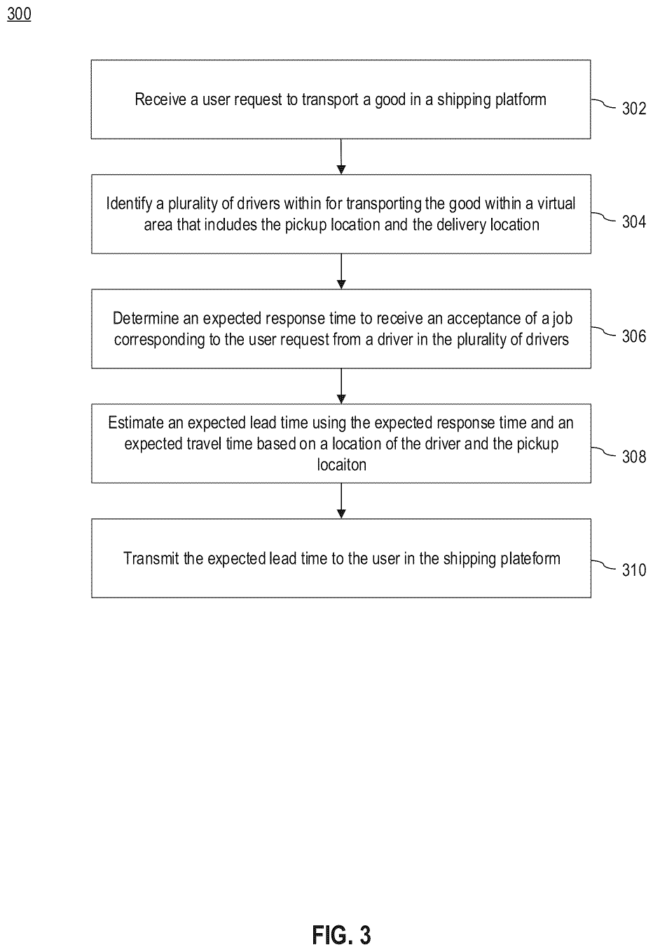

FIG. 3 illustrates a flowchart depicting an exemplary method 300 of operating the logistical management system 100 for estimating a lead time, according to aspects of the present disclosure. In non-limiting aspects, method 300 may be performed on either of the first device 102, the second device 106, or the third device 108. In non-limiting aspects, portions of method 300 may be performed on the first device 102, the second device 106, and/or the third device 108. For the purposes of discussion with respect to FIG. 3, and throughout the rest of this disclosure, it is assumed the steps of method 300 are performed on the second device 106. In aspects, method 300 may be performed using software modules. In non-limiting aspects, instructions (e.g., source code) stored on a non-transitory computer readable medium on the second device 106 may be executed to cause any hardware units of the second device 106, such as a processor, to process the stored instructions to have the software modules perform the functions of method 300.

As shown in FIG. 3, the method 300 begins by receiving a user request to transport a good in a shipping platform at, for instance, the second device 106 from, for instance, the first device 102 at step 302. The user request may contain, among other things, a pickup location and a destination location for a package and/or item to be transported. Since different items need to handled differently during transport—fresh flowers are handled differently than a bundle of bricks, which are both handled differently than hazardous chemicals—the request may also specify a number of different characteristics about the package. The characteristics may include volume, weight, a hazard level, a content, a durability, a shape, dimension measurements, a fragility of the item, a density of the package, and/or any other characteristic of the package that could be relevant to shipping. The user request may further include desired delivery time and/or desired delivery cost. The shipping platform may be a shipping software downloaded in the first device 102 and the third device 108 enabling communication there between and/or with the second device 106.

At step 304, the second device 106 may identify a plurality of drivers, e.g., the third devices 108, for transporting the good available within a virtual area that includes the pickup location. In some aspects, the virtual area may also include the destination location. For example, the virtual area may be a predefined distance or region from the package pickup location. The predefined distance or region can relate to or correspond to a city or city limits, or a geographical area in which the package pickup location is identified. An available driver that is one hundred miles away from the package pickup location, for example, would be determined to not be within the predefined distance (e.g., fifteen miles) of the user's pick up location, and therefore, would not be determined to be capable of providing transport for the package or item. In addition, a plurality of drivers may be tracked as a geofence database which stores information about a plurality of geofences. A geofence can correspond to a geographic region or area and can be defined by a perimeter. A perimeter of a geofence can be defined in a variety of ways, e.g., using three or more location data points or can be defined using a radius value from a center location data point of the geofence (e.g., a circumference of a circular shaped geofence). A POSA will recognize how to define and implement the geofence in search of drivers.

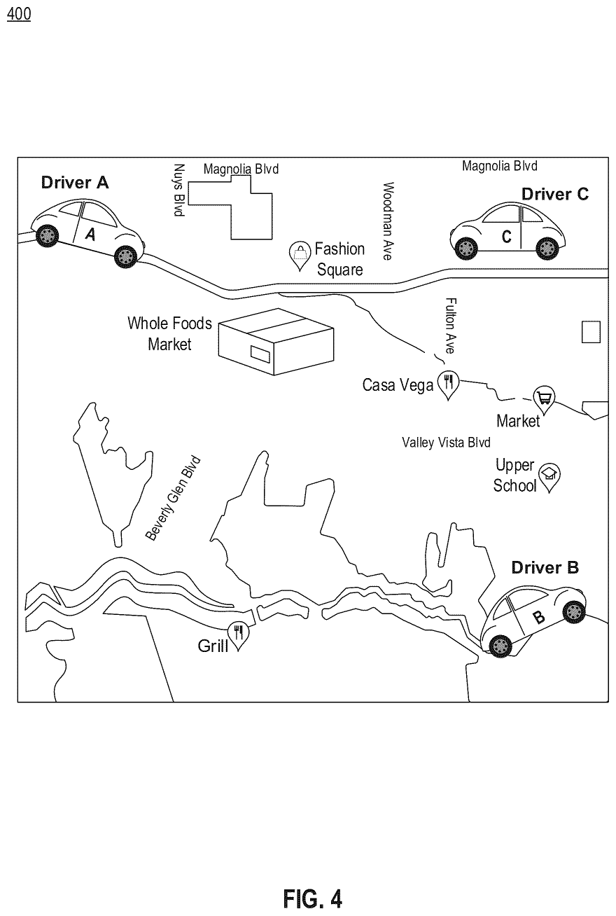

For instance, FIG. 4 shows identified drivers near a package pickup location in a virtual area. In this example, there are three drivers identified. The second device 106 may be configured to consider certifications of the identified drivers. For instance, in this example, it is possible that not every driver identified in the virtual map is certified to deliver the specific user's request. Accordingly, the second device 106 can be configured to only select drivers that have the appropriate certifications to carry that commodity type. In some aspects, each driver's profile when he or she logs in with the third device 108 may be linked to a corresponding driver profile maintained by the second device 106. According to some aspects, the driver profile maintained by server (e.g., second device 106) may contain additional data including certifications, vehicle information, vehicle capacity, driver history, etc. Once it is determined that the identified drivers are certified and available to deliver a specific package, based on the driver profiles (e.g., driver's package delivery request acceptance history, etc.) and the current location of the drivers, the available drivers can be ranked in the order, e.g., Driver A, Driver B, and Driver C in FIG. 4.

Various driver profiles can be accumulatively stored in determining the driver's preference. For instance, history data on a driver's tendency of rejecting when a distance from Driver A to the pickup location is greater than, e.g., 10 miles and/or when a distance between the pickup location and the final destination is less than, e.g., 1 mile, may be stored. Similarly, history data on a driver's tendency of accepting based on the location and distance information, or driver's tendency of accepting regardless of distances of the pickup location and the final destination. The history data is not limited to the driver's preference in distance, but it may include driver's habit of not responding to a request for more than a certain period of time, driver's accident history data, driver history data on job incompletion/cancellation history data, driver history data on misdelivery or not following the specific delivery request, driver's ratings/reviews by previous customers, etc. The data stored may further include the driver's smoking habit, the driver's driving records, and many others. In non-limiting aspects, all these factors and others may be considered in ranking the potential drivers which are registered in the logistical management system 100. Such an order ranking can be used in the expected response time calculation which will be described in detail later in this disclosure.

As also described above, according to aspects of the disclosure, the delivery requires a driver that is certified or registered in the data store element 110 via the shipping platform. That is, even if there are more than three drivers in the area near the pickup location, the second device 106 can communicate and send the package delivery request only to the certified drivers (e.g., three drivers as shown in FIG. 4). In addition, if there is no specific delivery requirement input in the first device 102, any registered drivers would be qualified for the package delivery and ranked based on the history data.

In non-limiting aspects, and as shown in step 306, an expected response time to receive an acceptance of a job corresponding to the user request from a driver among the plurality of drivers may be determined. In general, the response time may vary based on each circumstance of one or more drivers that there may be a significant wait time until one of the available drivers accepts and confirms the job request. The method according to various aspects can estimate the expected response time using an optimized algorithm and provide to the user without wait time, as described throughout this disclosure.

The method 300 may then estimate an expected lead time at step 306 using the expected response time estimated at step 306 and an expected travel time based on a location of the driver and the package or item pickup location. The expected travel time can be estimated based on the location of the driver and the pickup location that user has provided, considering various factors such as, speed limits, the number of traffic lights, time of the day (e.g., rush hour, etc.). A POSA will recognize and understand an algorithm for calculating a travel time.

In non-limiting aspects, once the expected lead time is estimated, the second device 106 can transmit the expected lead time to the user or the first device 102 in the shipping platform, e.g., on a display screen of the first device 102 or play a sound on the first device 102. Transmitting the expected lead time to the user is not limited to a virtual method and an audible method, such that the expected lead time delivery method can be customized based on customer's needs. For example, the first device 102 may have a haptic controller to provide vibration in a certain pattern to be recognized by a customer with visual and hearing limitations. Any types of controller or system for delivery time information can be integrated into the first device 102. Alternatively, or in addition, an additional hardware device may be connected to and communicate with, wirelessly or with wire, the first device 102 for providing an output to a user (e.g., customer).

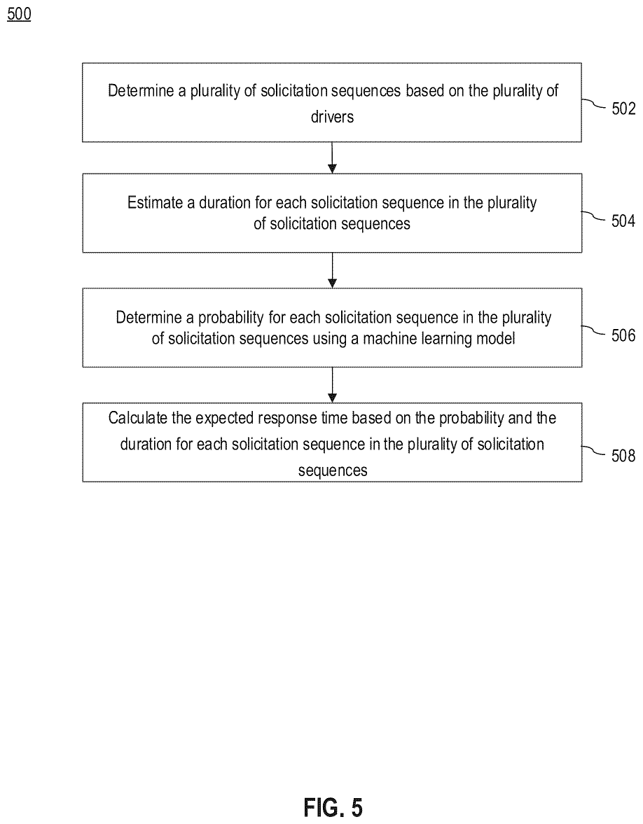

FIG. 5 is a flowchart depicting a method 500 of operating the logistical management system 100 to determine the expected response time once a plurality of drivers (e.g., Driver A, Driver B, and Driver C in FIG. 4), which are registered in the data store element 110, are identified and ranked. The method 500 could be used to perform step 306 of FIG. 3, that is, FIG. 5 provides further details of how step 306 of FIG. 3 is performed. In the present disclosure, it will be assumed that there may be Driver A, Drivers A and B, or Driver A, B, and C, but no more than three drivers, available in the virtual area for convenience. In an actual situation, there may be one driver, two drivers, three drivers, or more. That is, the descriptions and the examples described herein should be understood as some of exemplary aspects, but not limiting to thereto.

As shown FIG. 5, the method 500 begins by determining a plurality of solicitation sequences based on the plurality of drivers at step 502. For example, if there are N number of available drivers in the virtual map, the drivers can be ranked in the order as D¹, D², . . . , D^{N}. Here, driver D¹ can be assumed to be the first driver (e.g., Driver A in FIG. 4) to be offered a package delivery request or solicitation, and driver D^{N} can be assumed to be the last driver to be requested. Further, with reference to FIG. 6A which shows a graphical illustration of exemplary responses to delivery of a package, according to aspects of the present disclosure, an event of a driver “j” accepting (“A”), rejecting (“R”), or timing-out (“T”, neither accepting nor rejecting for a predetermined time, or a driver manually selecting an option of timing-out) on the kₜₕ request may be expressed as D^{j}(Aₖ), D^{j}(Rₖ), and D^{j}(Tₖ). With the above-described denotations, any possible solicitation sequence can be expressed. As one example, a situation, in which the first driver who has received a package delivery request times-out twice and then rejects, the second driver who has received the package delivery request once the first driver has rejected rejects the request immediately, and the third driver who has received the package delivery request once the second driver has rejected accepts after timing-out once, can be expressed as follows:

D¹(T₁), D¹(T₂), D¹(R₃), D²(R₁), D³(T₁), D³(A₂).

The above sequence is merely one possible sequence of solicitations that there may be a numerous possible sequences based on the number of drivers, the number of timing-out of each driver, etc. For instance, each sequence can be expressed as follows when assuming there are N number of drivers:

$$\begin{matrix}{S}_{1} = {D}^{1} ( {A}_{1} ) \\ {S}_{2} = {D}^{1} ( {T}_{1} ) , {D}^{I} ( {A}_{2} ) \\ {S}_{3} = {D}^{1} ( {T}_{1} ) , {D}^{1} ( {T}_{2} ) , {D}^{1} ( {A}_{3} ) \\ ⋮ \\ {S}_{k} = {D}^{1} ( {R}_{1} ) , {D}^{2} ( {A}_{2} ) \\ {S}_{k + 1} = {D}^{1} ( {R}_{1} ) , {D}^{2} ( {T}_{1} ) , {D}^{2} ( {A}_{2} ) \\ {S}_{k + 2} = {D}^{1} ( {R}_{1} ) , {D}^{2} ( {T}_{1} ) , {D}^{2} ( {T}_{2} ) , {D}^{2} ( {A}_{3} ) \\ ⋮\end{matrix}$$

FIG. 6B shows a graphical illustration of exemplary soliciting scenarios when there are a plurality of available drivers, according to aspects of the present disclosure. In these examples, with also reference to FIGS. 4 and 6A, there is Scenario 1 in which a first driver (e.g., Driver A in the first order based on the history data as explained above) has timed-out and has rejected on the 4^{th} request. Then, a second driver (e.g., Driver B) may receive the package delivery order as the 5^{th} request once the first driver rejects. In Scenario 1, the second driver rejects the 5^{th} request, such that the package delivery order is then requested to a third driver (e.g., Driver C) who is in the third ranking. The third driver rejects the 6^{th} request and then finally accepts the package delivery order on the 7^{th} request. This scenario can be expressed as follows:

D¹(T₁), D¹(T₂), D¹(T₃), D¹(R₄), D²(R₁), D³(T₁), D³(A₂).

Using this method, Scenario 2 of FIG. 6B can be expressed as follows:

D¹(T₁), D¹(R₂), D²(T₁), D²(T₂), D²(A₃).

In non-limiting aspects, solicitation scenarios as exemplary described above can be also built in a tree diagram as shown in FIG. 6C. The tree diagram in FIG. 6C merely shows some scenarios among a plurality of scenarios however the branch can continuously expand to include any possible scenarios considering the given number of available drivers. Such a tree diagram can be used in calculating a probability which will be described later.

In non-limiting aspects, at step 504, the method 500 estimates a duration for each solicitation sequence in the plurality of solicitation sequences. For example, each possible sequence Sj (e.g., S₁, S₂, . . . S_{K+2}) implicitly may have a length of time it takes for the sequence to process, e.g., the sequence D¹(A₁) might take one minute while D¹(T₁), D¹(T₂), D¹(T₃), D¹(T₄), D¹(A₅) might take 5 minutes. In non-limiting aspects, the predictive algorithms can be trained using machine learning and/or artificial intelligence techniques, using tools such as TensorFlow™ or PyTorch.

In addition, a machine learning model can encompass one or more input data. In various aspects, a machine learning model can receive an input (e.g., driver behavior data) from the second device 106 which communicates with the data store element 110, and based on the input identify patterns or associations in order to predict a given output, e.g., a duration it takes for a driver to provide a response to a package request delivery (accept, reject, or time-out). The driver behavior data may be the above-described history data accumulated over the time that each driver may develop a pattern of accepting, rejecting or timing-out based on various factors (e.g., distance, area, time of day, etc.). “Machine learning” as described herein, in particular aspects, corresponds to algorithms that parse or extract features of historical data (e.g., historical behavioral of driver's response time, historical behavioral of driver's tendency of accepting a request based on time of day, distance from a pickup location and/or destination, characteristics of the package (whether the package requires a special handle), etc.), learn (e.g., via training) about the historical data by making observations or identifying patterns in the historical data.

Therefore, each sequence determined at step 502 can be expressed in time by summing the estimated duration of each scenario. For example, in scenario S₁, the first driver D¹ accepts the request right away, and based on the historical data, the duration for the driver D¹ to accept a request may be 1 minute. In scenario S₂, the first driver D¹ times-out and then accepts the request. In this case, if the time-out duration is set to be, e.g., 2 minutes, the duration for S₂ becomes 3 minutes (2 minute+1 minute) without any optimization. This duration can be shortened when the optimization, which will be described later, is applied to be, e.g., 1 minute. The time-out duration may be preset so that if a driver does not response to a package delivery request, a next driver will be solicited or requested after a certain period time that is the threshold or time-out duration. Further, the number of timing-out can be limited so that there may be no more than a certain number of timing-out. Similarly, the historical data can include a rejection time for each driver to be used in estimating a duration for each solicitation sequence in the plurality of solicitation sequences.

In some aspects, there may be one or more newly registered drivers without any history data stored in the machine learning model. The method 500 can apply generic data, which may be the average number of a plurality of registered drivers for each response.

In non-limiting aspects, and as shown in step 506, a probability for each solicitation sequence in the plurality of solicitation sequences can be determined. For example, FIG. 6D shows a graphical illustration of an exemplary probability of one scenario when there are a plurality of available drivers (two drivers in this example), according to aspects of the present disclosure. In this exemplary scenario, the first driver (e.g., Driver A) times-out and rejects the package delivery order on the second request, and the second driver (e.g., Driver B) in the next order times-out three times and accepts the package delivery order. A probability of this exemplary scenario in FIG. 6D may be expressed as A_{T}¹×A_{R}²×B_{T}¹×B_{T}²×B_{A}³ or D¹(T₁)×D¹(R₂)×D²(T₁)×D²(T₂)×D²(A₃). A probability of any given scenario can be calculated using the above technique.

In non-limiting aspects, with reference to FIG. 6C, solicitation scenarios can be generated in a tree diagram to cover every possible scenario. If a path ends with an Accept (e.g., Driver A on the first row of the first branch), the scenario generation can end. In addition, if a driver times-out a set number of times (e.g., a driver times-out three times as shown in the last row of the third branch in FIG. 6C), the package delivery request may move on to the next driver. In addition, a probability of each scenario can be calculated as each scenario is being generated. If a particular scenario has a probability below a certain threshold, the scenario generation may terminate since child scenarios have probabilities less than or equal to the parent scenario.

FIG. 6E is an illustrative probability tree diagram for calculating scenario probabilities as one example, by combining the solicitation tree diagram of FIG. 6C and a probability calculation example of 6D. In this example of FIG. 6E, it is assumed that three drivers (Driver A, Driver B, and Driver C ranked in order) are available in the virtual map. In this example, the scenario probabilities can be calculated once all scenarios have been created, which would become 18 floating point operations per second (FLOPS) in the specific example of FIG. 6E. Therefore, the number of FLOPS depends on the number of scenarios which further depend on the number of available drivers.

The method 500 can then move on to step 508 of calculating the expected response time based on the probability for each solicitation sequence determined at step 506 and the duration for each solicitation sequence in the plurality of solicitation sequences estimated at step 504. In non-limiting aspects, an expected time to get a response (e.g., “expected response time”) can be calculated according to the following Equation (1):

Expected response time=Σ_{All possible S}_{ⱼ}Probability(Sⱼ)×Duration(Sⱼ) (1)

In addition, with the probabilities and duration of each possible solicitation sequence, further probabilities and parameters can be calculated, such as a probability that any driver will accept the request, a probability that the package delivery order request will end with no driver accepting, and an expected variance regarding the expected lead time.

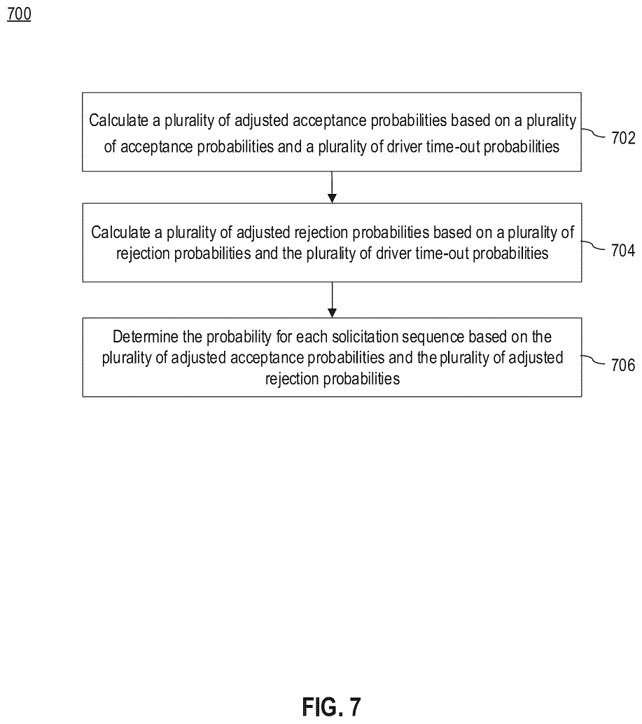

FIG. 7 is a flowchart depicting a method 700 of operating the logistical management system 100 to determine a probability for each solicitation sequence. The method 700 could be used to perform step 506 of FIG. 5, that is, FIG. 7 provides further details, alternatively or additionally, of how step 506 of FIG. 5 is performed.

The method 700 begins by calculating a plurality of adjusted acceptance probabilities based on a plurality of acceptance probabilities and a plurality of driver time-out probabilities at step 702, and calculating a plurality of adjusted rejection probabilities based on a plurality of rejection probabilities and the plurality of driver time-out probabilities at step 704.

For instance, to calculate an expected response time for all available drivers using Equation (1), for example, a probability that any given driver will Accept, Reject, or Time-out on any given solicitation, can be assigned with a value. That is, probabilities for D^{j}(Aₖ), D^{j}(Rₖ), and D^{j}(Tₖ) for any “j” and “k” needs to be determined (step 506). Then, a time it takes to get a response from a driver on any given solicitation needs to be assigned (step 504). Once the probabilities and the durations have been determined, each possible sequence of solicitations can be created in the matrix form as follows:

| Solicitation number | Accept | Reject | Time-out |
|---|---|---|---|
| 1 | D^{j}(A₁) | D^{j}(R₁) | D^{j}(T₁) |
| 2 | D^{j}(A₂) | D^{j}(R₂) | D^{j}(T₂) |
| . | . | . | . |
| . | . | . | . |
| . | . | . | . |
| n | D^{j}(Aₙ) | D^{j}(Rₙ) | D^{j}(Tₙ) |
| . | . | . | . |
| . | . | . | . |
| . | . | . | . |

If a driver accepts or rejects nth solicitation, the driver must have timed-out n−1 times previously. For example, assuming a first driver times-out twice and then rejects, a second driver rejects the job offer immediately, and a third driver accepts after timing-out once. This situation is equivalent and can be interpreted as a situation in which a first driver rejects the third solicitation, a second driver rejects immediately, and a third driver accepts the second solicitation, and can be expressed as [D¹(T₁), D¹(T₂), D¹(R₃)], [D²(R₁)], [D³(T₁), D³(A₂)]. Based on this analysis, each possible sequence of solicitations created in the new matrix form as follows:

| Solicitation number | Accept | Reject |
|---|---|---|
| 1 | D^{j}(A₁) | D^{j}(R₁) |
| 2 | D^{j}(T₁) × D^{j}(A₂) | D^{j}(T₁) × D^{j}(R₂) |
| . | . | . |
| . | . | . |
| . | . | . |
| n | $( {\prod }_{k = 1}^{n - 1} {D}^{j} ( {T}_{k} ) ) \times {D}^{j} ( {A}_{n} )$ | $( {\prod }_{k = 1}^{n - 1} {D}^{j} ( {T}_{k} ) ) \times {D}^{j} ( {R}_{n} )$ |
| . | . | . |
| . | . | . |
| . | . | . |

As can be seen above, by employing adjusted acceptance probabilities (e.g., combining acceptance probabilities and time-out probabilities) and adjusted rejection probabilities (e.g., combining rejection probabilities and time-out probabilities), computation time can be significantly reduced. For example, the probability of any solicitation sequence is calculated by multiplying the probabilities D¹(T₁), D¹(T₂), D¹(R₃) which amounts to 2 floating point operations per second (FLOPS). By performing this multiplication at the beginning and calling it each time it is needed, it is possible to save 1 FLOP per solicitation sequence.

Referring to FIG. 6E, which is an illustrative probability calculation for some of scenarios among a plurality of scenarios, the scenario probabilities can be calculated at the end once all scenarios have been created as described above in performing step 506. In this case, there may be total of 18 FLOPS for these 3 exemplary scenarios shown in FIG. 6E.

However, if adjusted acceptance probabilities and adjusted rejection probabilities are calculated as in steps 702 and 704, the probability for each solicitation sequence based on the adjusted acceptance probabilities and the adjusted rejection probabilities can be calculated in a significantly shorter amount of time. That is, the method 700 can perform the probability calculation at step 706 in a shorter amount of time than performing the probability calculation when the adjusted probabilities.

The revised matrix reflecting the adjusted acceptance and rejection probabilities can be simply expressed as follows in Equations (3) and (4), respectively:

Adjusted Acceptance Probability D^{j}(aₙ)=(Πₖ₌₁ⁿ⁻¹D^{j}(Tₖ))×D^{j}(Aₙ) (2)

Adjusted Rejection Probability D^{j}(rₙ)=(Πₖ₌₁ⁿ⁻¹D^{j}(Tₖ))×D^{j}(Rₙ) (3)

As expressed in Equations (2) and (3), a driver's time-out sequence can be eliminated when enumerating a solicitation sequence. For example, a situation in which a driver “j” accepts the fourth solicitation D^{j}(A₄) can be understood as the driver has timed-out three times, that is, the first three solicitations, and then finally accepts on the fourth solicitation. As another example, a sequence D¹(T₁), D¹(T₂), D¹(R₃), D²(R₁), D³(T₁), D³(A₂) can be equivalently expressed as D¹(r₃), D²(r₁), D³(a₂).

In non-limiting aspects, each adjusted acceptance probability among the plurality of adjusted acceptance probabilities is calculated by multiplying a probability that the driver timed-out a predetermined number of times by an acceptance probability among the plurality of acceptance probabilities, and each adjusted rejection probability among the plurality of adjusted rejection probabilities is calculated by multiplying a probability that the driver timed-out a predetermined number of times by a rejection probability among the plurality of rejection probabilities.

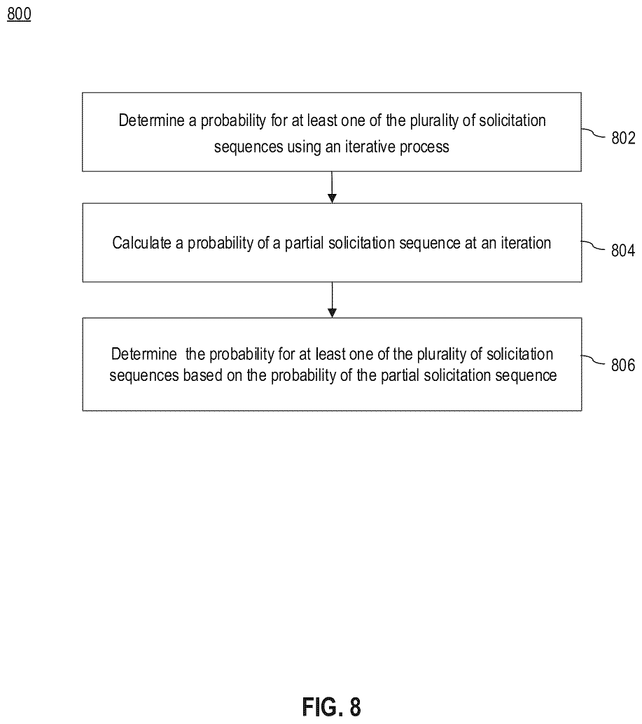

FIG. 8 is a flowchart depicting a method 800 of operating the logistical management system 100 to determine a probability for each solicitation sequence, according to another aspect of the present disclosure. The method 800 could be used to perform step 506 of FIG. 5, that is, FIG. 8 provides further details, alternatively or additionally, of how step 506 of FIG. 5 is performed.

The method 800 begins by determining a probability for at least one of the plurality of solicitation sequences using an iterative process at step 802. An iterative process is a mathematical procedure that uses an initial value to generate a sequence of improving approximate solutions, in which the n-th approximation is derived from the previous ones. In aspects, assuming all of the possible solicitation sequences that the first driver D¹ rejects on the third round, D¹(r₃), can be iteratively develop the next round of possible solicitation results as follows:

$${D}^{1} ( {r}_{3} ) \to \{ \begin{matrix}{D}^{1} ( {r}_{3} ) , {D}^{2} ( {r}_{1} ) \\ {D}^{1} ( {r}_{3} ) , {D}^{2} ( {a}_{1} ) \\ {D}^{1} ( {r}_{3} ) , {D}^{2} ( {r}_{2} ) \\ {D}^{1} ( {r}_{3} ) , {D}^{2} ( {a}_{3} ) \\ ⋮ \\ {D}^{1} ( {r}_{3} ) , {D}^{2} ( {r}_{N} ) \\ {D}^{1} ( {r}_{3} ) , {D}^{2} ( {a}_{N} )\end{matrix}$$

In this example, any solicitation sequence that ends with a driver accepting is finished and not carried forward. Thus, with each possible solicitation result listed for the second driver D², the solicitation sequences for every sequence that resulted in a reject is developed. This iterative process can continue until all possible drivers are considered. In this process, the partial solicitation sequence's probability is calculated once (multiplied) and carried forward at each iterative step.

$${D}^{1} ( {r}_{3} ) \to \{ \begin{matrix}{D}^{1} ( {r}_{3} ) , {D}^{2} ( {r}_{1} ) \to \{ \begin{matrix}{D}^{1} ( {r}_{3} ) , {D}^{2} ( {r}_{1} ) , {D}^{3} ( {r}_{1} ) \\ {D}^{1} ( {r}_{3} ) , {D}^{2} ( {r}_{1} ) , {D}^{3} ( {a}_{1} ) \\ ⋮ \\ {D}^{1} ( {r}_{3} ) , {D}^{2} ( {r}_{1} ) , {D}^{3} ( {r}_{N} ) \\ {D}^{1} ( {r}_{3} ) , {D}^{2} ( {r}_{1} ) , {D}^{3} ( {a}_{N} )\end{matrix} \\ {D}^{1} ( {r}_{3} ) , {D}^{2} ( {a}_{1} ) \\ {D}^{1} ( {r}_{3} ) , {D}^{2} ( {r}_{2} ) \to \{ \begin{matrix}{D}^{1} ( {r}_{3} ) , {D}^{2} ( {r}_{2} ) , {D}^{3} ( {r}_{1} ) \\ {D}^{1} ( {r}_{3} ) , {D}^{2} ( {r}_{2} ) , {D}^{3} ( {a}_{1} ) \\ ⋮ \\ {D}^{1} ( {r}_{3} ) , {D}^{2} ( {r}_{2} ) , {D}^{3} ( {r}_{N} ) \\ {D}^{1} ( {r}_{3} ) , {D}^{2} ( {r}_{2} ) , {D}^{3} ( {a}_{N} )\end{matrix} \\ {D}^{1} ( {r}_{3} ) , {D}^{2} ( {a}_{3} ) \\ ⋮ \\ {D}^{1} ( {r}_{3} ) , {D}^{2} ( {r}_{N} ) \to \{ \begin{matrix}{D}^{1} ( {r}_{3} ) , {D}^{2} ( {r}_{N} ) , {D}^{3} ( {r}_{1} ) \\ {D}^{1} ( {r}_{3} ) , {D}^{2} ( {r}_{N} ) , {D}^{3} ( {a}_{1} ) \\ ⋮ \\ {D}^{1} ( {r}_{3} ) , {D}^{2} ( {r}_{N} ) , {D}^{3} ( {r}_{N} ) \\ {D}^{1} ( {r}_{3} ) , {D}^{2} ( {r}_{N} ) , {D}^{3} ( {a}_{N} )\end{matrix} \\ {D}^{1} ( {r}_{3} ) , {D}^{2} ( {a}_{N} )\end{matrix}$$

Referring back to FIG. 6E, which is an illustrative probability tree diagram for calculating scenario probabilities, when the iterative process is applied, scenario probabilities is calculated for 8 FLOPS for 3 scenarios in the example of FIG. 6E. On the other hand, if scenario probabilities are calculated at the end once all the possible scenarios have been created, there will be 18 FLOPS for the same 3 scenarios. Thus, there is a significant reduce in calculating time particularly when there are a number of available drivers.

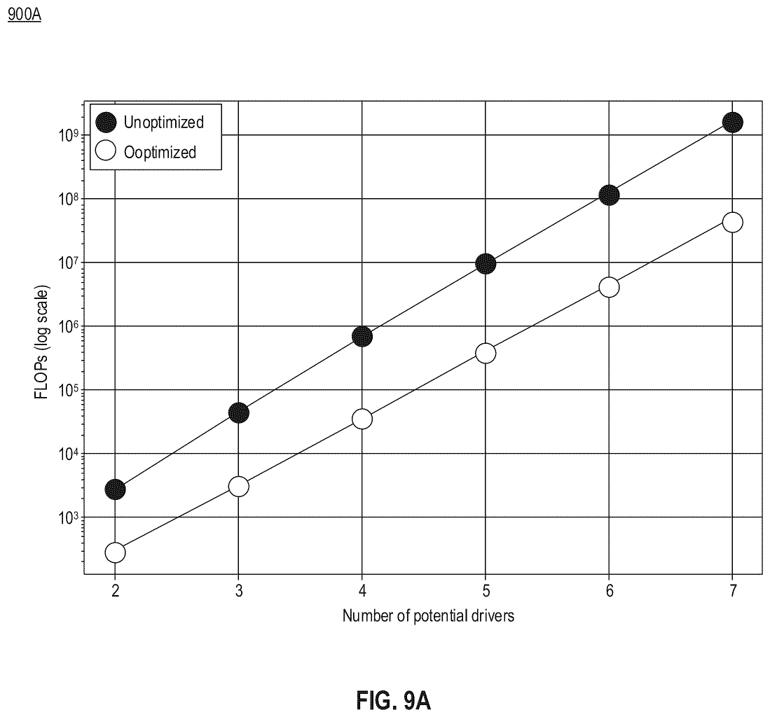

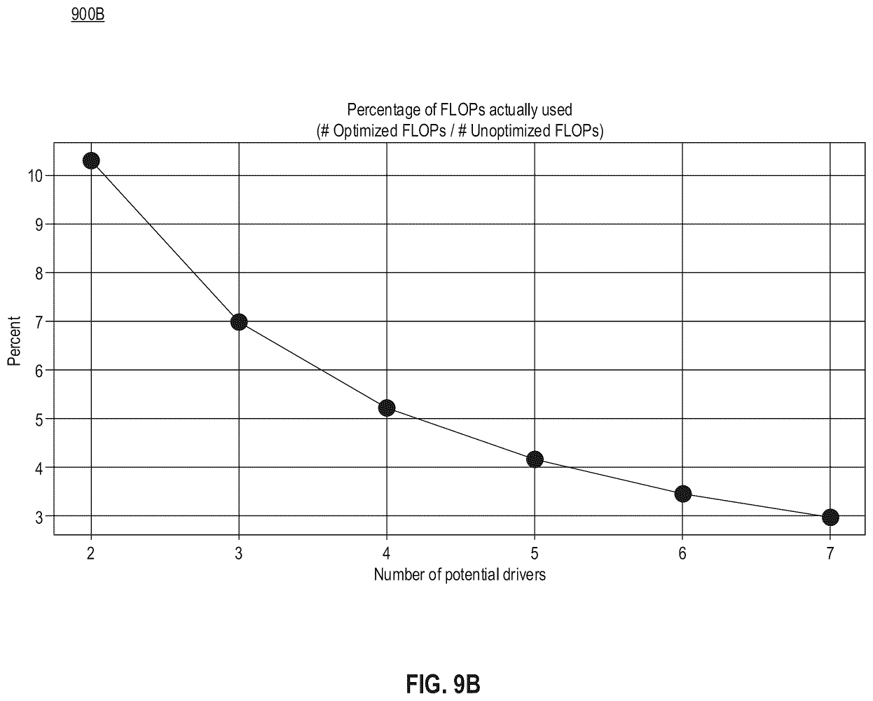

FIG. 9A is a graph comparing the number of FLOPS obtained by probability calculation with and without using both techniques of adjusted acceptance and rejection probabilities, and an iterative probability calculation, according to aspects of the present disclosure. The x-axis on the graph represents the number of drivers (e.g., 2, 3 . . . 7) in the virtual map, and the y-axis on the graph represents the number of FLOPS, plotted in a logarithmic scale, needed to calculate a probability for each number of driver. The line with solid circles represents results obtained by using the generic probability calculation described above (e.g., calculating probabilities for every scenario), and the line with hollow circles represents results obtained by using the optimized algorithm (e.g., iterative process). The graph in FIG. 9A shows that the number of FLOPS is significantly reduced with the optimized algorithm thus reducing the calculating time.

FIG. 9B is a graph illustrating the percentage of FLOPS obtained by probability calculation with and without using both techniques of adjusted acceptance and rejection probabilities, and an iterative probability calculation. In FIG. 9B, the x-axis represents the number of available or potential drivers while the y-axis represents the percent of FLOPS actually used. As can be seen, the more the number of drivers, the less the percent of FLOPS used. That is, the techniques of adjusted probabilities and iterative probability calculation can reduce the calculation time in percentage compared to non-optimized calculation even further when there are more drivers to be considered compared to when the non-optimized calculation is used.

In non-limiting aspects, when there is no available driver (e.g., registered driver in the system) in the virtual map within a certain distance from the package pickup location, the logistical management system 100 may send a request to a third party agent (e.g., trusted third party contractor) to communicate available drivers found in the virtual map but not registered in the logistical management system 100. Any available third party agent drivers may be considered as new drivers so that generic data can be used in the probabilities and a time to response estimation.

The logistical management system 100 can also be used to significantly improve industries such as transportation and logistics. For example, when there are a number of drivers available in a virtual map, the logistical management system 100 may be used to quickly and efficiently estimate an expected time to get a response from a driver without waiting until one among a number of drivers accepts a package delivery request of a customer. Accordingly, as a customer can receive time information (e.g., a time for a driver to arrive and pick up the package, a time for a driver to deliver the package from the pickup location to the destination, etc.), the customer satisfaction can be increased. Further, the presently described methods are computationally inexpensive while reducing calculating times, and a smaller computing storage system can be used so that the calculation cost can be significantly saved.

The methods 300, 500, 700, and 800 described above may be implemented as instructions stored on a non-transitory computer readable medium to be executed by one or more computing devices, such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the logistical management system 100 or installed as a removable portion of the logistical management system 100. The non-transitory computer readable medium may be integrated as part of the first device 102, the second device 106, the third device 108, or a combination thereof.

### Components of the System

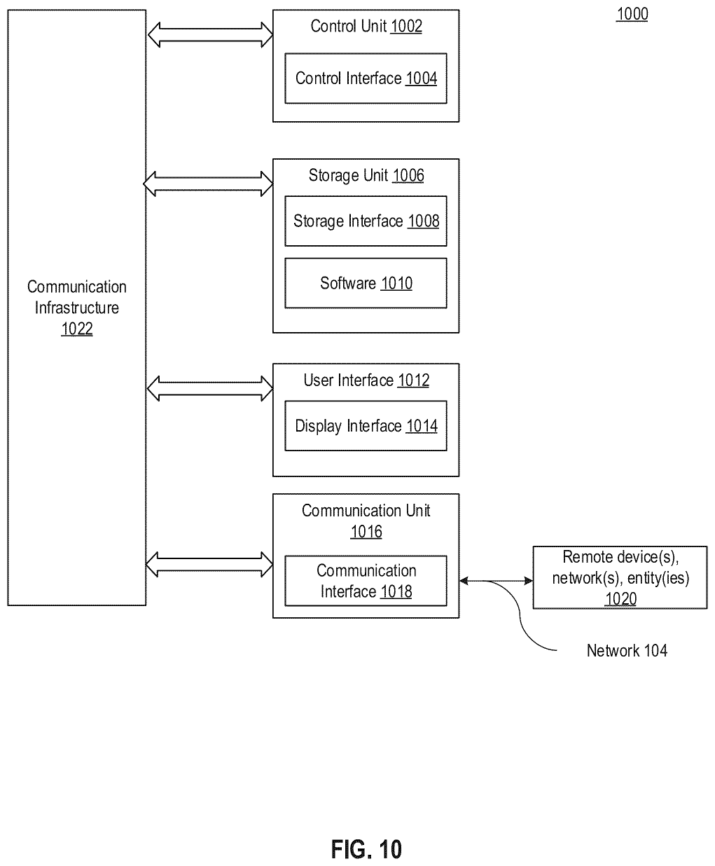

FIG. 10 is an example architecture 1000 of the components implementing the logistical management system 100, according to aspects of the present disclosure. In non-limiting aspects, the components may be a part of any of the devices of the logistical management system 100 (e.g., the first device 102, the second device 106, or the third device 108) and may be the hardware components on which the methods of the logistical management system 100 are performed. In aspects, the components can include a control unit 1002, a storage unit 1006, a communication unit 1016, and a user interface 1012. The control unit 1002 may include a control interface 1004. The control unit 1002 may execute a software 1010 to provide some or all of the intelligence of logistical management system 100. The control unit 1002 may be implemented in a number of different ways. For example, the control unit 1002 may be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The control interface 1004 may be used for communication between the control unit 1002 and other functional units or devices of logistical management system 100. The control interface 1004 may also be used for communication that is external to the functional units or devices of logistical management system 100. The control interface 1004 may receive information from the functional units or devices of logistical management system 100, or from remote devices 1020, or may transmit information to the functional units or devices of logistical management system 100, or to remote devices 1020. The remote devices 1020 refer to units or devices external to logistical management system 100.

The control interface 1004 may be implemented in different ways and may include different implementations depending on which functional units or devices of logistical management system 100 or remote devices 1020 are being interfaced with the control unit 1002. For example, the control interface 1004 may be implemented with optical circuitry, waveguides, wireless circuitry, wireline circuitry to attach to a bus, an application programming interface, or a combination thereof. The control interface 1004 may be connected to a communication infrastructure 1022, such as a bus, to interface with the functional units or devices of logistical management system 100 or remote devices 1020.

The storage unit 1006 may store the software 1010. For illustrative purposes, the storage unit 1006 is shown as a single element, although it is understood that the storage unit 1006 may be a distribution of storage elements. Also for illustrative purposes, the storage unit 1006 is shown as a single hierarchy storage system, although it is understood that the storage unit 1006 may be in a different configuration. For example, the storage unit 1006 may be formed with different storage technologies forming a memory hierarchical system including different levels of caching, main memory, rotating media, or off-line storage. The storage unit 1006 may be a volatile memory, a nonvolatile memory, an internal memory, an external memory, or a combination thereof. For example, the storage unit 1006 may be a nonvolatile storage such as nonvolatile random access memory (NVRAM), Flash memory, disk storage, or a volatile storage such as static random access memory (SRAM) or dynamic random access memory (DRAM).

The storage unit 1006 may include a storage interface 1008. The storage interface 1008 may be used for communication between the storage unit 1006 and other functional units or devices of logistical management system 100. The storage interface 1008 may also be used for communication that is external to logistical management system 100. The storage interface 1008 may receive information from the other functional units or devices of logistical management system 100 or from remote devices 1020, or may transmit information to the other functional units or devices of logistical management system 100 or to remote devices 1020. The storage interface 1008 may include different implementations depending on which functional units or devices of logistical management system 100 or remote devices 1020 are being interfaced with the storage unit 1006. The storage interface 1008 may be implemented with technologies and techniques similar to the implementation of the control interface 1004.

The communication unit 1016 may allow communication to devices, components, modules, or units of logistical management system 100 or to remote devices 1020. For example, the communication unit 1016 may permit the logistical management system 100 to communicate between its components or devices, for example the first device 102, the second device 106, and the third device 108. The communication unit 1016 may further permit the devices of logistical management system 100 to communicate with remote devices 1020 such as an attachment, a peripheral device, or a combination thereof through the network 104.

As indicated, the network 104 may span and represent a variety of networks and network topologies. For example, the network 104 may be a part of a network and include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 104. Cable, Ethernet, digital subscriber line (DSL), fiber optic lines, fiber to the home (FTTH), and plain old telephone service (POTS) are examples of wired communication that may be included in the network 104. Further, the network 104 may traverse a number of network topologies and distances. For example, the network 104 may include direct connection, personal area network (PAN), local area network (LAN), metropolitan area network (MAN), wide area network (WAN), or a combination thereof.

The communication unit 1016 may also function as a communication hub allowing devices of the logistical management system 100 to function as part of the network 104 and not be limited to be an end point or terminal unit to the network 104. The communication unit 1016 may include active and passive components, such as microelectronics or an antenna, for interaction with the network 104.

The communication unit 1016 may include a communication interface 1018. The communication interface 1018 may be used for communication between the communication unit 1016 and other functional units or devices of logistical management system 100 or to remote devices 1020. The communication interface 1018 may receive information from the other functional units or devices of logistical management system 100, or from remote devices 1020, or may transmit information to the other functional units or devices of the system 100 or to remote devices 1020. The communication interface 1018 may include different implementations depending on which functional units or devices are being interfaced with the communication unit 1016. The communication interface 1018 may be implemented with technologies and techniques similar to the implementation of the control interface 1004.

The user interface 1012 may present information generated by logistical management system 100. In aspects, the user interface 1012 allows a user of logistical management system 100 to interface with the devices of logistical management system 100 or remote devices 1020. The user interface 1012 may include an input device and an output device. Examples of the input device of the user interface 1012 may include a keypad, buttons, switches, touchpads, soft-keys, a keyboard, a mouse, or any combination thereof to provide data and communication inputs. Examples of the output device may include a display interface 1014. In aspects, a lead time and/or delivery time may be displayed on the display interface 1014. The control unit 1002 may operate the user interface 1012 to present information generated by logistical management system 100. The control unit 1002 may also execute the software 1010 to present information generated by logistical management system 100, or to control other functional units of logistical management system 100. The display interface 1014 may be any graphical user interface such as a display, a projector, a video screen, or any combination thereof.

In aspects, the logistical management system 100 can further use predictive algorithms to make a recommendation to the user. The predictive algorithms refer to an algorithm or a set of algorithms that may be implemented by the logistical management system 100 to learn patterns about the paths/routes, destinations, carriers, etc. over a period of time. In aspects, based on the learned patterns, the logistical management system 100 can make predictions about which paths/routes are likely to be the best paths/routes for a user. In aspects, the predictive algorithms can also take into account the user's filtering criteria when providing a recommendation. For example, if a user has a particular carrier he or she would like to use, the predictive algorithms can base the predictions made on learned information about that particular carrier and only make recommendations for that particular carrier. In aspects, the predictive algorithms may be trained using machine learning and/or artificial intelligence techniques, using tools such as TensorFlow™ to learn patterns about the paths/routes, destinations, carriers, etc.

In aspects, the predictive algorithms may be trained, for example, to learn patterns for a particular real-world destination. In aspects, the learned patterns may be, for example, related to what times and dates the paths/routes to the particular destination are busiest, what seasons if any the paths/routes to the particular destination have frequent delays, what days and/or months at the particular destination have unfavorable weather patterns such that transportation to and from the particular destination is interrupted or has to be re-routed frequently, etc. Similarly, the predictive algorithms may be trained to learn patterns about particular carriers. For example, the predictive algorithms may be trained to learn which carriers consistently meet their estimated arrival times, which carriers have frequent delays, which carriers have frequently broken or damaged vessels, the monetary costs associated with a particular carrier for paths/routes, etc. The aforementioned are examples of patterns that may be learned by the predictive algorithms. A POSA will recognize that other patterns consistent with the aforementioned examples can also be learned using the predictive algorithms.

In aspects, once trained, the predictive algorithms may be used to make recommendations regarding which paths/routes best fit the needs of the user. In this way, the logistical management system 100 can provide the best possible path/route to a user. Moreover, the predictive algorithms allow the logistical management system 100 to continuously learn patterns about which paths/routes may best fit the needs of users and optimize recommendations to users. The ability to do so can provide the logistical management system 100 the ability to recommend paths/routes that are determined to be the most reliable for transporting goods and personnel. In aspects, this can result in users saving money and time by taking the recommended paths/routes, because the most reliable paths/routes will more likely result in less of a chance that the users must re-route shipments due to weather, delays, unreliable carriers, etc.

The above detailed description and aspects of the disclosed logistical management system 100 are not intended to be exhaustive or to limit the disclosed logistical management system 100 to the precise form disclosed above. While specific examples for logistical management system 100 are described above for illustrative purposes, various equivalent modifications are possible within the scope of the disclosed logistical management system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting methods 300, 500, 700, and 800 described above, and logistical management system 100 are cost-effective, highly versatile, and accurate, and may be implemented by adapting components for ready, efficient, and economical manufacturing, application, and utilization. Another important aspect of aspects of the present disclosure is that it valuably supports and services the historical trend of reducing costs, simplifying systems, and/or increasing performance.

These and other valuable aspects of the aspects of the present disclosure consequently further the state of the technology to at least the next level. While the disclosed aspects have been described as the best mode of implementing logistical management system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the scope of the disclosure should be determined not by the aspects illustrated, but by the appended claims and their equivalents.

What is claimed is:

1. A method for estimating lead time, the method comprising:
receiving, by one or more processors, a user request to transport a good in a shipping platform, wherein the user request includes a pickup location and a delivery location;
identifying a plurality of drivers for transporting the good within a virtual area that includes the pickup location and the delivery location;
determining an expected response time to receive an acceptance of a job corresponding to the user request from a driver in the plurality of drivers using a stochastic process;
estimating an expected lead time using the expected response time and an expected travel time based on a location of the driver and the pickup location; and
transmitting the expected lead time to the user in the shipping platform.

2. The method of claim 1, the determining the expected response time further comprising:
determining a plurality of solicitation sequences based on the plurality of drivers;
estimating a duration for each solicitation sequence in the plurality of solicitation sequences;
determining a probability for each solicitation sequence in the plurality of solicitation sequences using a machine learning model; and
calculating the expected response time based on the probability and the duration for each solicitation sequence in the plurality of solicitation sequences.

3. The method of claim 2, further comprising:
constraining the plurality of solicitation sequences from an infinite number of solicitation sequences by applying one or more of a time-out threshold, a path-length threshold, and a probability threshold.

4. The method of claim 2, the determining the probability for each solicitation sequence further comprising:
calculating a plurality of adjusted acceptance probabilities based on a plurality of acceptance probabilities and a plurality of driver time-out probabilities;
calculating a plurality of adjusted rejection probabilities based on a plurality of rejection probabilities and the plurality of driver time-out probabilities; and
determining the probability for each solicitation sequence based on the plurality of adjusted acceptance probabilities and the plurality of adjusted rejection probabilities.

5. The method of claim 4, wherein:
each adjusted acceptance probability among the plurality of adjusted acceptance probabilities is calculated by multiplying a probability that the driver timed-out a predetermined number of times by an acceptance probability among the plurality of acceptance probabilities; and
each adjusted rejection probability among the plurality of adjusted rejection probabilities is calculated by multiplying a probability that the driver timed-out a predetermined number of times by a rejection probability among the plurality of rejection probabilities.

6. The method of claim 2, the determining the probability for each solicitation sequence further comprising:
determining a probability for at least one of the plurality of solicitation sequences using an iterative process comprising:
calculating a probability of a partial solicitation sequence at an iteration; and
determining the probability for at least one of the plurality of solicitation sequences based on the probability of the partial solicitation sequence.

7. The method of claim 6, wherein the probability of the partial solicitation sequence at the iteration is calculated in accordance with the probability of another partial solicitation sequence calculated at a previous iteration.

8. The method of claim 2, wherein the calculating the expected response time further comprising:
extracting a training set of data for each driver for the machine learning model, wherein the training set of data comprises driver acceptance history information as an acceptance probability, driver time-out history information as a time-out probability, and driver rejection history information as a rejection probability.

9. The method of claim 2, wherein, when a driver is identified as a new driver, preset driver information is used as a training set of data in the machine learning model.

10. The method of claim 8, further comprising:
prioritizing the plurality of drivers within the virtual area based on the training set, wherein the stochastic process is performed in the prioritized order of the plurality of drivers.

11. The method of claim 1, the identifying the plurality of drivers further comprising:
determining the plurality of drivers in the virtual area that satisfy one or more requirements of a certification for transporting the good.

12. The method of claim 9, further comprising, upon determining that no driver satisfies the one or more requirements in the virtual area:
searching for one or more drivers outside the virtual area for transporting the good.

13. The method of claim 9, further comprising, upon determining that no driver satisfies the one or more requirements in the virtual area:
requesting to one or more third-party agent drivers in search of transporting the good.

14. The method of claim 13, wherein, when one or more third-party agent drivers are identified as available drivers, the preset driver information is used in the machine learning model.

15. The method of claim 1, wherein the transmitting of the output comprises at least one of:
generating a visual output on a display of a user device;
generating an audible output on the user's device; or
generating a haptic output on the user's device.

16. The method of claim 1, wherein the user request further includes at least one of size information, content information, special care requirement information, or weight information of the good for transporting.

17. The method of claim 1, further comprising:
determining a probability that no driver among the plurality of drivers accepts the user request for transporting of the good.

18. The method of claim 1, further comprising:
determining an expected variance of the expected lead time.

19. A non-transitory computer-readable device having instructions stored thereon that, when executed by at least one computing device, causes the at least one computing device to perform operations comprising:
receiving a user request for transporting of a good via a shipping platform, wherein the request includes a pickup location and a delivery location;
identifying a plurality of eligible drivers for transporting the good within a virtual area that includes the pickup location and the delivery location;
determining an expected response time to receive an acceptance of the request from a driver in the plurality of drivers using a stochastic process;
estimating an expected lead time using the expected response time and an estimated expected travel time that is derived based on a trained driver model for transporting of the good; and
transmitting the expected lead time to the user in the shipping platform.

20. A system for estimating lead time comprising:
a memory; and
at least one processor coupled to the memory and configured to:
receive a user request for transporting of a good via a shipping platform, wherein the request includes a pickup location and a delivery location;
identify a plurality of eligible drivers for transporting the good within a virtual area that includes the pickup location and the delivery location;
determine an expected response time to receive an acceptance of the request from a driver in the plurality of drivers using a stochastic process;
estimate an expected lead time using the expected response time and an estimated expected travel time that is derived based on a trained driver model for transporting of the good; and
transmit the expected lead time to the user in the shipping platform.
